(19) United States
(12) Patent Application Publication
(10) Pub. No.: US 2015/0262043 A1
(43) Pub. Date: Sep. 17, 2015

(54) INFORMATION PROCESSING APPARATUS, INFORMATION PROCESSING METHOD, AND INFORMATION PROCESSING SYSTEM

(71) Applicants: Nobuyuki SAEKI, Tokyo (JP); Teruaki TAKAHASHI, Kanagawa (JP)

(72) Inventors: Nobuyuki SAEKI, Tokyo (JP); Teruaki TAKAHASHI, Kanagawa (JP)

(21) Appl. No.: 14/641,790

(22) Filed: Mar. 9, 2015

(30) Foreign Application Priority Data
Mar. 13, 2014 (JP) 2014-050457

(51) Int. Cl. G06K 15/02; G06F 3/12

(52) U.S. Cl. CPC G06K 15/1831; G06K 15/1849; G06K 15/1868; G06F 3/1211; G06F 3/1276

(57) ABSTRACT

An information processing apparatus includes: a first drawing unit that draws graphic data of a predetermined format as a bitmap image in a temporary drawing area; and a second drawing unit that performs drawing processing based on the graphic data of the predetermined format to generate print data, and uses, as a drawing result with respect to a drawing element of a particular type that has been predetermined, the particular type being of types of drawing elements defined in the predetermined format, an image at coordinates where the drawing element is to be arranged, the image being of the bitmap image drawn in the temporary drawing area by the first drawing unit.

### CROSS-REFERENCE TO RELATED APPLICATIONS

The present application claims priority to and incorporates by reference the entire contents of Japanese Patent Application No. 2014-050457 filed in Japan on Mar. 13, 2014.

### BACKGROUND OF THE INVENTION

1. Field of the Invention

This invention relates to an information processing apparatus, an information processing method, and an information processing system, which generate print data by performing drawing processing based on graphic data of a predetermined format.

2. Description of the Related Art

When a document is printed, data representing an image to be printed have been conventionally known to be spooled and printed in Enhanced Metafile (EMF) format, which is an image file format of Microsoft Windows (registered trademark) for graphic data. In this case, a printer driver that controls a printer to be used in the printing converts the data in EMF format (hereinafter, referred to as “EMF data”) to data in a page description language (PDL) interpretable by the printer and transmits the converted data to the printer to cause the printer to execute the printing.

Further, in recent office environments, a multi-function peripheral (MFP), a laser printer, a printer server, and the like are often connected to a network to make multiple output devices available. Under such an environment, as described in Japanese Patent Application Laid-open No. 2011-002881, a technique has been known, for assigning and outputting EMF data spooled via a virtual printer driver to other printer drivers as appropriate.

In the technique described in Japanese Patent Application Laid-open No. 2011-002881, the printer drivers to be assigned may vary, in terms of vendors, page description languages to be used, and the like. Depending on the printer driver, some of types of records possibly included in the EMF data may not be properly interpretable. If a printer driver is caused to process a record that is unable to be interpreted properly, a desired print result is not able to be obtained, with that part being painted over in black, for example.

Such a problem may occur similarly when graphic data other than EMF data are used. Further, the problem may also occur in an architecture other than that using a virtual printer driver as described in Japanese Patent Application Laid-open No. 2011-002881.

In view of the above circumstances, there is a need to enable print data that are able to be properly processed by a printer driver to be generated.

### SUMMARY OF THE INVENTION

It is an object of the present invention to at least partially solve the problems in the conventional technology.

An information processing apparatus includes: a first drawing unit that draws graphic data of a predetermined format as a bitmap image in a temporary drawing area; and a second drawing unit that performs drawing processing based on the graphic data of the predetermined format to generate print data, and uses, as a drawing result with respect to a drawing element of a particular type that has been predetermined, the particular type being of types of drawing elements defined in the predetermined format, an image at coordinates where the drawing element is to be arranged, the image being of the bitmap image drawn in the temporary drawing area by the first drawing unit.

An information processing method includes: first drawing including drawing graphic data of a predetermined format as a bitmap image in a temporary drawing area; and second drawing including performing drawing processing based on the graphic data of the predetermined format to generate print data, and using, as a drawing result with respect to a drawing element of a particular type that has been predetermined, the particular type being of types of drawing elements defined in the predetermined format, an image at coordinates where the drawing element is to be arranged, the image being of the bitmap image drawn in the temporary drawing area at the first drawing.

An information processing system includes: a first drawing unit that draws graphic data of a predetermined format as a bitmap image in a temporary drawing area; and a second drawing unit that performs drawing processing based on the graphic data of the predetermined format to generate print data, and uses, as a drawing result with respect to a drawing element of a particular type that has been predetermined, the particular type being of types of drawing elements defined in the predetermined format, an image at coordinates where the drawing element is to be arranged, the image being of the bitmap image drawn in the temporary drawing area by the first drawing unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a relation between PCs and printers in an environment to which this invention is applied;

FIG. 2 is a diagram illustrating a hardware configuration of the PCs illustrated in FIG. 1;

FIG. 3 is a diagram illustrating a configuration of functions for instructing a printer, which the PC illustrated in FIG. 1 includes, to execute a print job;

FIG. 4 is a diagram illustrating characteristics of a printer driver processing EMF data;

FIG. 5 is another diagram thereof;

FIG. 6 is a diagram illustrating an example of an image described by the EMF data;

FIG. 7 is a diagram illustrating an example of the EMF data describing the image of FIG. 6;

FIG. 8 is a diagram illustrating another example thereof;

FIG. 9 is a diagram illustrating an example of a defect that occurs in a print result;

FIG. 10 is a diagram illustrating a configuration of functions provided in an output data generating unit for processing the EMF data;

FIG. 11 is a diagram illustrating an example of replacement rectangle data;

FIG. 12 is a flow chart of a print data generating process;

FIG. 13 is a flow chart continued from FIG. 12;

FIG. 14 is a diagram corresponding to FIG. 10 and illustrating a functional configuration of an output data generating unit in a comparative example;

FIG. 15 is a flow chart of a print data generating process in the comparative example, the print data generating process corresponding to FIG. 12 and FIG. 13;

FIG. 16 is a flow chart of a print data generating process in a first modified example, the print data generating process corresponding to FIG. 12; and

FIG. 17 is a diagram corresponding to FIG. 10 and illustrating a functional configuration of an output data generating unit in a second modified example.

### DETAILED DESCRIPTION OF THE PREFERRED EMBODIMENTS

Hereinafter, embodiments of this invention will be specifically described.

### Embodiment

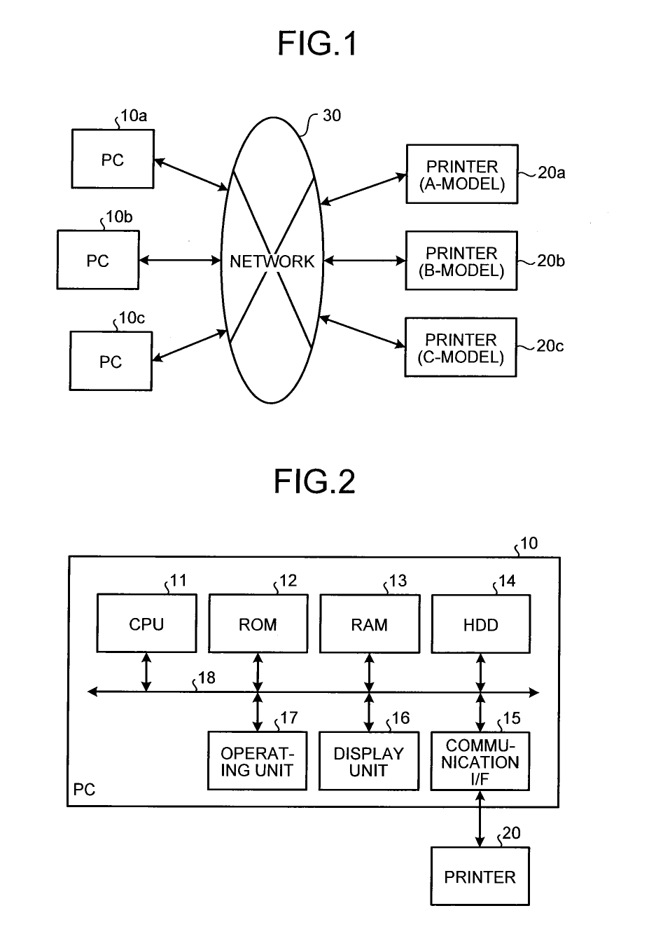

### FIG. 1 to FIG. 13

FIG. 1 illustrates an example of a relation between PCs and printers in an environment to which this invention is applied.

In the environment illustrated in FIG. 1, a plurality of PCs 10 (10a to 10c) are connected to a plurality of printers 20 (20a to 20c) via a network 30, respectively.

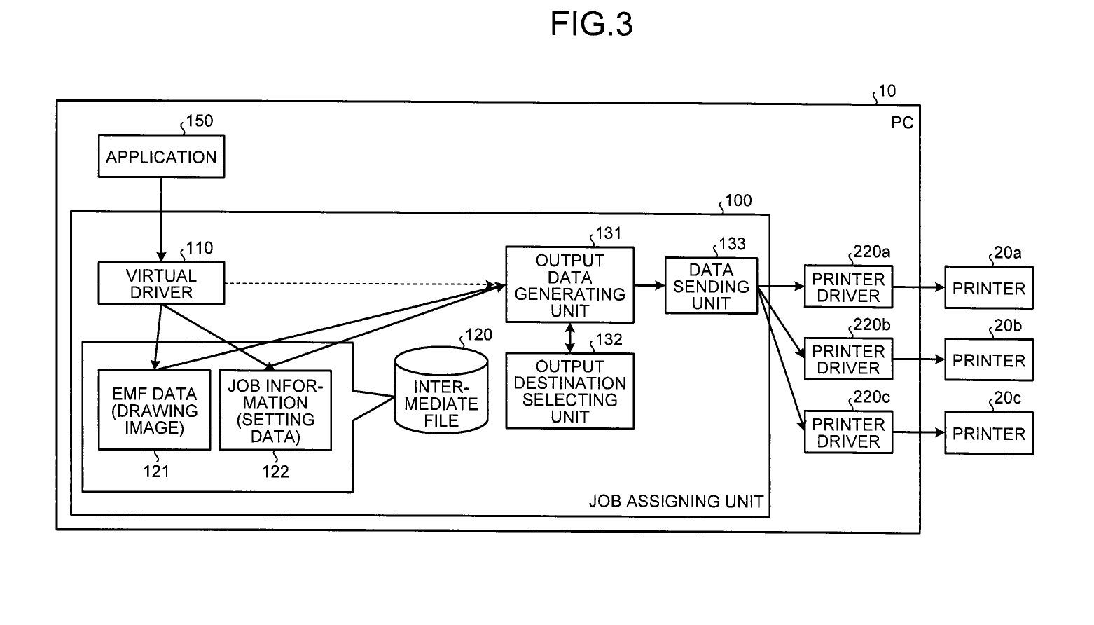

Of these, each of the PCs 10a to 10c is an embodiment of an information processing apparatus of this invention and instructs a later described printer driver 220 to execute image formation (which is, herein, printing) by functions of a job assigning unit 100 illustrated in FIG. 3.

When that is done, the job assigning unit 100 selects which printer 20 to be caused to execute a print job for a job execution request received from an application and supplies necessary data to the printer driver 220 corresponding to that printer to cause that printer driver 220 to instruct the printer 20 to execute printing.

The PC 10a to PC 10c are not necessarily of a common model, but characteristic functions in this embodiment do not particularly differ among the apparatuses and thus in the following description, functions of one of them, referred to as “PC 10” as a representative thereof, will be described.

Further, each of the printers 20a to 20c is an image forming apparatus that forms an image on paper by printing according to a print execution instruction from the printer driver 220. The printers 20a to 20c may be of models different from one another or may include those of the same model. Further, all or a part of the printers 20a to 20c may be connected to a local printer port of the PC 10 without connection via the network 30.

The network 30 may be either a wire network or a wireless network, and any network of an arbitrary standard may be used as the network 30.

Next, FIG. 2 illustrates a hardware configuration of the PC 10.

Hardware of the PC 10 may be a general computer. That is, the PC 10 includes a CPU 11, a ROM 12, a RAM 13, a hard disk drive (HDD) 14, a communication interface (I/F) 15, a display unit 16, and an operating unit 17, and is configured by connecting these by a system bus 18.

By the CPU 11 executing a program stored in the ROM 12 or HDD 14 using the RAM 13 as a work area, the PC 10 as a whole is controlled and later described various functions, such as control of the printer 20 and generation of print data, are realized.

The HDD 14 is a non-volatile storage medium (storage means) and stores therein various programs executed by the CPU 11 and various data that will be described later.

The communication I/F 15 is an interface for communicating with an external device, such as the printer 20. A communication standard to be used may be, regardless of whether the communication is wired or wireless, arbitrary.

The display unit 16 is a display means, such as a display, for presenting information to an operator.

The operating unit 17 is an operating means, such as a key board and a mouse, or a touch panel, for receiving an operation from the operator.

The display unit 16 and the operating unit 17 may be external or an operation may be caused to be able to be received from an external terminal apparatus, such as the PC 10, via the network 30.

Next, FIG. 3 illustrates a configuration of functions, which the PC 10 has, for instructing the printer 20 to execute a print job.

As illustrated in FIG. 3, the PC 10 includes the job assigning unit 100, an application 150, and the printer driver 220 (220a to 220c).

Of these, the job assigning unit 100 selects by the output destination selecting unit 132, which of the plurality of printers 20a to 20c is to be used for printing, based on a print job execution request received from the application 150.

Based on the print job execution request, image data and print setting data, which are of a format that the printer driver 220 is able to handle and are for causing the selected printer 20 to execute the printing, are generated, and the generated image data and print setting data are transmitted to that printer driver 220.

The printer driver 220 controls the printer 20 to cause the printer 20 to execute the printing, based on the received image data and print setting data.

Thereby, based on the print job execution request output by the application 150, the proper printer 20 is able to be automatically selected and that printer 20 is able to be caused to execute the printing. Criteria for selecting a printer may be determined by using various information, such as a user name, a client name, address information, contents of print setting, the number of pages of a document, and presence or absence of a secret word.

The application 150 is a function realized by application software, and has a function of editing or operating a document according to an operation by a user. The function realized by this application 150 may be: word processing; image formation, editing, and processing; spreadsheet operation; or the like.

Describing more specifically a functional configuration of the job assigning unit 100, the job assigning unit 100 includes a virtual driver 110, an output data generating unit 131, the output destination selecting unit 132, and a data sending unit 133.

Of these, the virtual driver 110 is a Microsoft Universal Printer Driver Library (Unidrv) based mini driver and is a printer driver that is able to perform print setting corresponding to the public DEVMODE. The virtual driver 110 functions as a receiving means that receives a print job execution request from the application 150. Further, the virtual driver 110 has a function of extracting EMF data, which are graphic data that indicate print contents and that are of a predetermined format, from an enhanced metafile (EMF) spool file, which are print job data received with the print job execution request, and storing the extracted EMF data as EMF data (drawing image data) 121 in an intermediate file 120.

Further, the virtual driver 110 also has a function of storing print settings (also being a part of the print job data) received with the print job execution request in the intermediate file 120 as job information (print setting data) 122. The job information 122 also includes system information.

Further, the virtual driver 110 activates the output data generating unit 131 when the virtual driver 110 receives the print job execution request.

This output data generating unit 131 has a function of acquiring the EMF data 121 and job information 122 stored in the intermediate file 120, and generating, based on the acquired EMF data 121 and job information 122, data for causing the printer driver 220 to execute the printing.

Upon this generation, the output data generating unit 131 transmits information necessary for selection of a printer from the EMF data 121 and job information 122 to the output destination selecting unit 132, which is a selecting unit, and the output data generating unit 131 causes the output destination selecting unit 132 to select a printer to execute the print job for the EMF data 121 and job information 122. As described above, the criteria and rules for this selection may include various criteria and rules.

The output data generating unit 131 generates image data and print setting data, which are of a format that is able to be interpreted by the printer driver 220 for controlling printing in the printer 20 selected by the output destination selecting unit 132, and transmits the image data and print setting data to the data sending unit 133. Of these, the image data correspond to print data. Further, the output data generating unit 131 is able to process the EMF data 121 and/or job information by activating an arbitrary plug-in.

The data sending unit 133 has a function of transmitting the image data and print setting data transmitted from the output data generating unit 131 to the printer driver 220 selected by the output destination selecting unit 132 and requesting the print job execution based on the image data and print setting data.

As described above, the PC 10 is able to perform the necessary processing on the print job execution request output by the application 150 and thereafter cause the proper printer 20 to execute the processed job.

One of characteristic points of this embodiment is drawing processing performed when the output data generating unit 131 generates print data. Hereinafter, this point will be described.

First, characteristics of processing of EMF data by the printer driver 220 will be described.

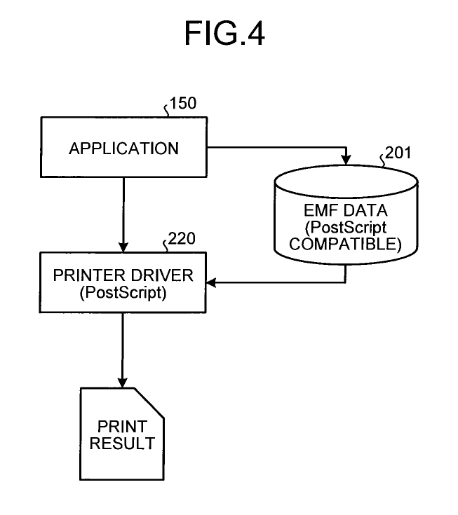

FIG. 4 illustrates a flow of a process when the printer driver 220 receives the EMF data 163 from the application 150 without the EMF data going through the virtual driver 110. The printer driver is assumed to be a driver that uses PostScript as a page description language. Some of drawing elements (units of drawing contents called “records” in EMF data) defined in EMF format and possibly included in EMF data are not able to be interpreted properly by using PostScript and not able to be processed normally by the printer driver 220.

However, even in this case, if the transmission destination of the EMF data from the application 150 is the printer driver 220, an operating system (OS, herein assumed to be Microsoft Windows (registered trademark)) is able to know that the printer driver 220 is a printer that uses PostScript. An application programming interface (API) of the OS converts data indicating print contents, the data being output by the application 150 to the API, to EMF data 201 using only drawing elements interpretable in PostScript and transmits the EMF data 201 to the printer driver 220.

Therefore, the printer driver 220 is able to properly process the transmitted EMF data 201 and convert the transmitted EMF data 201 to a page description by PostScript. The printer driver 220 then transmits the converted data to the printer 20 and causes the printer 20 to execute printing, and a proper print result is able to be obtained.

However, as illustrated in FIG. 3, when EMF data are transmitted from the application 150 to the printer driver 220 via the virtual driver 110, there is a problem.

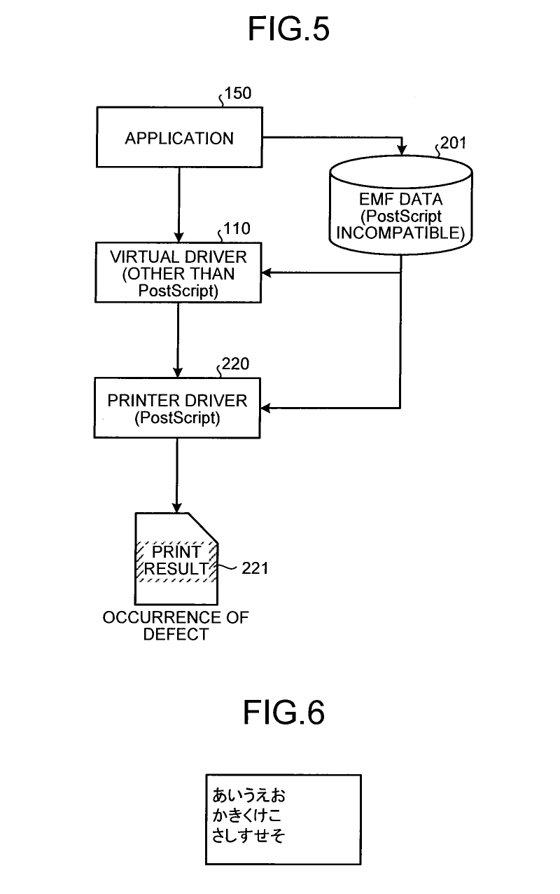

FIG. 5 illustrates a flow of a process in that case.

In the case of FIG. 5, a transmission destination of the EMF data from the application 150 is the virtual driver 110. It is assumed herein that the virtual driver 110 uses a language other than PostScript, as a page description language. In this case also, similarly to the case of FIG. 4, the OS is able to know a page description language used by the virtual driver 110. The API of the OS converts data indicating print contents, the data being output by the application 150, to EMF data 202 using only drawing elements interpretable by a page description language (other than PostScript) used by the virtual driver 110 and transmits the converted EMF data 202 to the virtual driver 110. These EMF data 202 may include drawing elements that are not interpretable properly in PostScript.

The virtual driver 110 processes the EMF data 202 on its own and transmits the processed EMF data 202 to any of the printer drivers 220 by the function of the output data generating unit 131. When that is done, if special measures are not taken to cause the EMF data 202 to correspond to PostScript, even at the stage of being transmitted to the printer driver 220, the EMF data 202 may include drawing elements not properly interpretable in PostScript.

Accordingly, even if the printer driver 220 processes the transmitted EMF data 202, the EMF data 202 may not be able to be properly converted to a page description in PostScript. Even if such data are transmitted to the printer 20 to cause the printer 20 to execute printing, a proper print result may not be able to be obtained.

A drawing element of the EMF data not properly interpretable in PostScript may occur when, for example, a bold faced or italic font style is used. An example of a case of boldface will be described as an example of the drawing element not properly interpretable in PostScript.

As illustrated in FIG. 6, describing, as EMF data, an image in which, of three Japanese character strings, “A-I-U-E-O”, “Ka-Ki-Ku-Ke-Ko”, and “Sa-Shi-Su-Se-So”, the second line, “Ka-Ki-Ku-Ke-Ko” is bold faced, will be considered.

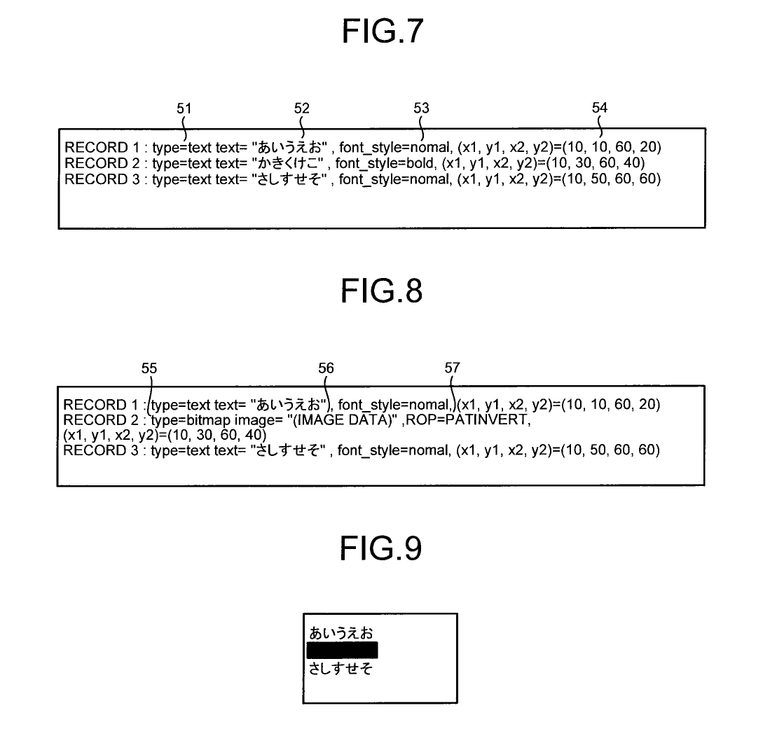

If the image in FIG. 6 is described as EMF data properly interpretable in PostScript, FIG. 7 is obtained. FIG. 7 illustrates only main parts of the EMF data. Similar things apply to FIG. 8.

The EMF data in FIG. 7 represent respective lines of the character strings with records 1 to 3. Indicated with a symbol, “51”, “type=text” is information indicating that data following thereafter is text. Indicated with a symbol, “52”, “text=“character string”” is information indicating the character string to be arranged. Indicated with a symbol, “53”, “font style=xxxx” is information indicating that the text for the corresponding record is to be normal or bold. Indicated with a symbol, “54”, “(x1, y1, x2, y2)=xxxx” is information indicating coordinates at which the drawing object (herein, text) for the corresponding record is arranged. These coordinates are coordinates at an upper left corner (x1, y1) and a bottom right corner (x2, y2) of a rectangular area in which the drawing object is arranged.

In contrast, the image in FIG. 6 is also able to be described as illustrated in FIG. 8.

In the EMF data of FIG. 8 also, a record 1 and a record 3 are the same as those of the example in FIG. 7. However, a record 2 is different therefrom. Indicated with a symbol, “55”, “type=bitmap” is information indicating that data following thereafter are bitmap data. Indicated with a symbol, “56”, “image=“(image data)”” is information indicating a position and a name of a file in which a bitmap image to be arranged has been stored. That is, in this example, the character string of the second line is expressed as an image. Indicated with a symbol, “57”, “ROP=PATINVERT” is a raster operation code specifying that a color of a specified pattern (bitmap) should be combined with a color of an arrangement destination area (for example, background) by using a logical XOR operator. Description of the coordinates is the same as that of the example in FIG. 7.

When PostScript is used, of the EMF data of FIG. 8, “ROP=PATINVERT” is not able to be interpreted. Therefore, if printing based on the EMF data of FIG. 8 is performed by using a printer driver using PostScript, as illustrated in FIG. 9, a defect of an object corresponding to the record 2 being printed in a state of being painted over in black occurs.

In order to prevent occurrence of such a defect, in this embodiment, the output data generating unit 131 positioned between the virtual driver 110 and the printer driver 220 performs appropriate processing on the EMF data 121.

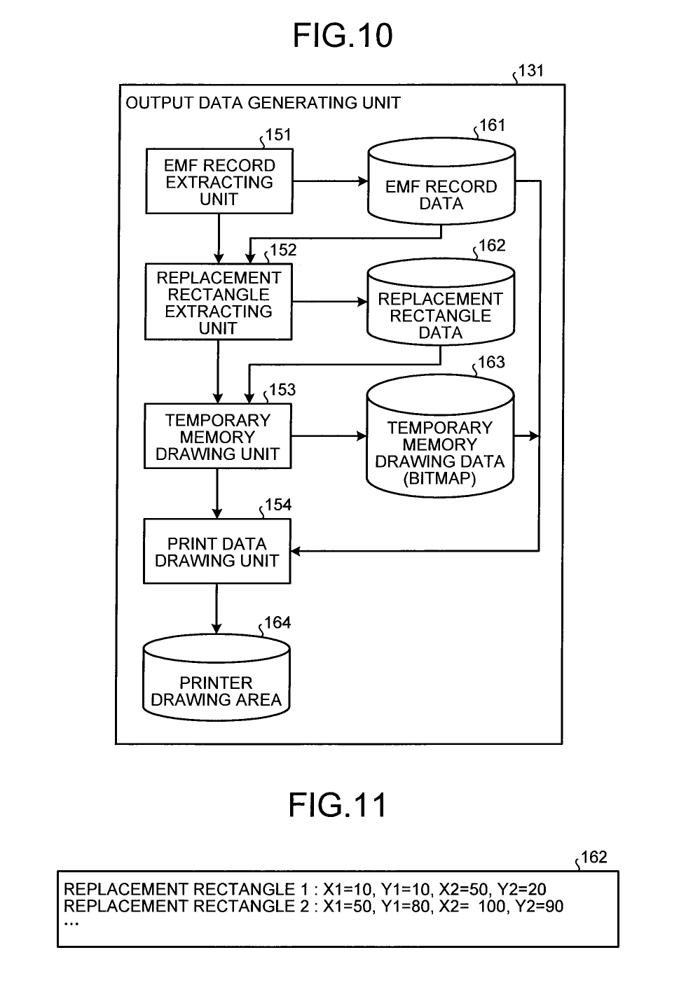

FIG. 10 illustrates a configuration of functions provided in the output data generating unit 131 for this processing.

The output data generating unit 131 is provided with an EMF record extracting unit 151, a replacement rectangle extracting unit 152, the temporary memory drawing unit 153, and print data drawing unit 154. EMF record data 161, replacement rectangle data 162, and temporary memory drawing data 163 are data generated and referred to when these respective units operate. A printer drawing area 164 is a memory area for generating EMF data to be transmitted to the printer driver 220 as print data.

A function of each unit in FIG. 10 will be described as an example in a case where EMF data interpretable in PostScript, which are print data, are generated, based on EMF data, which are graphic data and for which interpretability in PostScript is unknown (which are not guaranteed to be compatible with PostScript). However, as described later, a print data generating process performed by the output data generating unit 131 is not limited thereto. The graphic data are data indicating contents of an image, and the print data are data indicating contents of an image to be printed and are data for being transmitted to the printer driver 220 to cause the printer driver 220 to execute printing.

Of the respective units in FIG. 10, the EMF record extracting unit 151 has a function of extracting, from EMF data to be processed, EMF records (corresponding to the “records” illustrated in FIG. 7 and FIG. 8) and storing the EMF records as EMF record data 161. The EMF data to be processed are data that have been subjected to necessary processing excluding generation of print data performed by the respective units of FIG. 10, the necessary processing having been performed on the EMF data 121 in the intermediate file 120 by the output data generating unit 131.

The replacement rectangle extracting unit 152 has a function of extracting, from the EMF record data 161, a record including information not interpretable in PostScript, and storing, as the replacement rectangle data 162, coordinates of an area in which a drawing object corresponding to that record is arranged when the drawing object is drawn. This record extracted by the replacement rectangle extracting unit 152 is a drawing element of a particular type. Which type of record is to be extracted is set beforehand. Herein, a record including “PATINVERT” described with reference to FIG. 8 is assumed to be extracted, but the particular type is not limited to one type. Further, a shape of each area is a rectangle for a record extracted in consideration of PostScript, but depending on a type of the extracted record, another shape may be applicable.

FIG. 11 illustrates an example of the replacement rectangle data and these data include, for each drawing element of a particular type (for each “replacement rectangle” in FIG. 11), data of coordinates of an area in which a drawing object corresponding to that drawing element is arranged. In this example, since the shape of the area is rectangular, the coordinates of the area are represented by coordinates of the top left vertex (X1, Y1) and coordinates of the bottom right vertex (X2, Y2).

Next, the temporary memory drawing unit 153 has a function of a first drawing unit that draws each EMF record extracted by the replacement rectangle extracting unit 152 as a bitmap image in a later described temporary memory drawing area, while referring to the replacement rectangle data 162, and generates the temporary memory drawing data 163. A module, which is able to properly interpret and draw all types of record that are possibly included in EMF data, is used as this temporary memory drawing unit 153. For example, a drawing module for generating a bitmap image for being displayed on a display may be used. Further, the temporary memory drawing data 163 are a bitmap image including an image used in replacement of an EMF record when print data are generated.

The print data drawing unit 154 has a function of a second drawing unit that performs, based on the EMF record data 161, drawing processing on the printer drawing area 164, and generates print data in the printer drawing area 164. Upon this drawing processing, drawing elements of types other than the above mentioned particular type are written in the printer drawing area 164 as they are. As for the drawing element of the particular type, from the bitmap image of the temporary memory drawing data 163, an image at coordinates at which the corresponding drawing element is to be arranged is used as a drawing result with respect to that corresponding drawing element. That bitmap image is then drawn at those coordinates of the printer drawing area 164.

By the above described respective units, the output data generating unit 131 is able to replace, in EMF data to be processed, a record not interpretable in PostScript with a record for bitmap drawing interpretable in PostScript. As a result, EMF data interpretable in PostScript are able to be generated as print data. Contents of images represented by the EMF data to be processed and the generated print data are common. The print data are able to be properly processed by the printer driver 220 compatible with PostScript, to be used in controlling of printing by the printer 20.

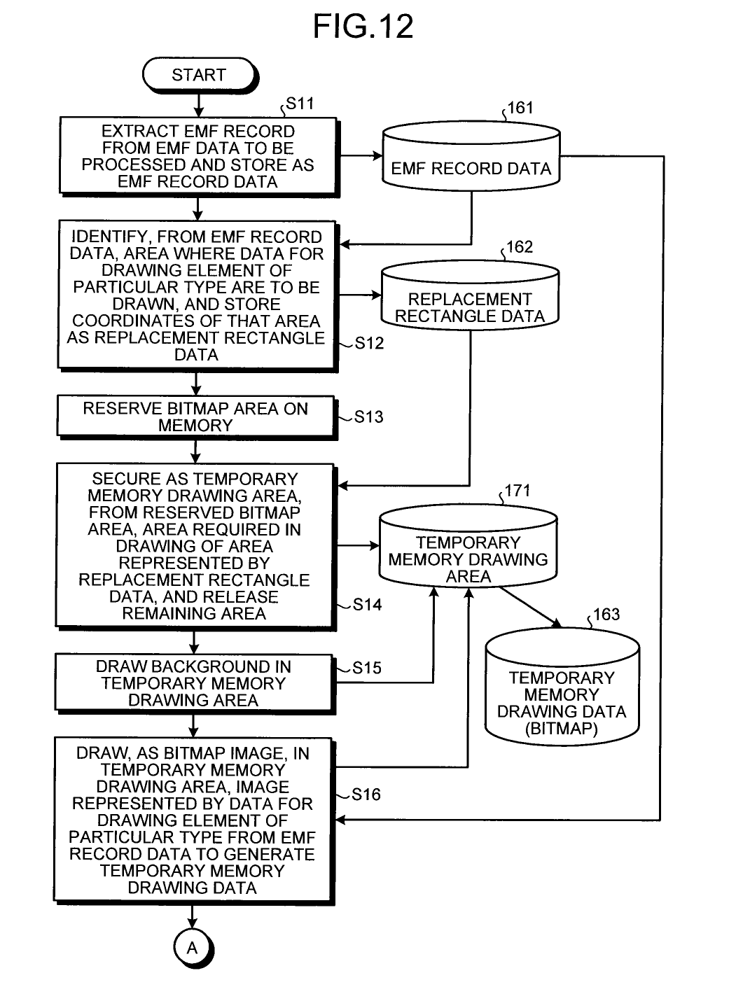

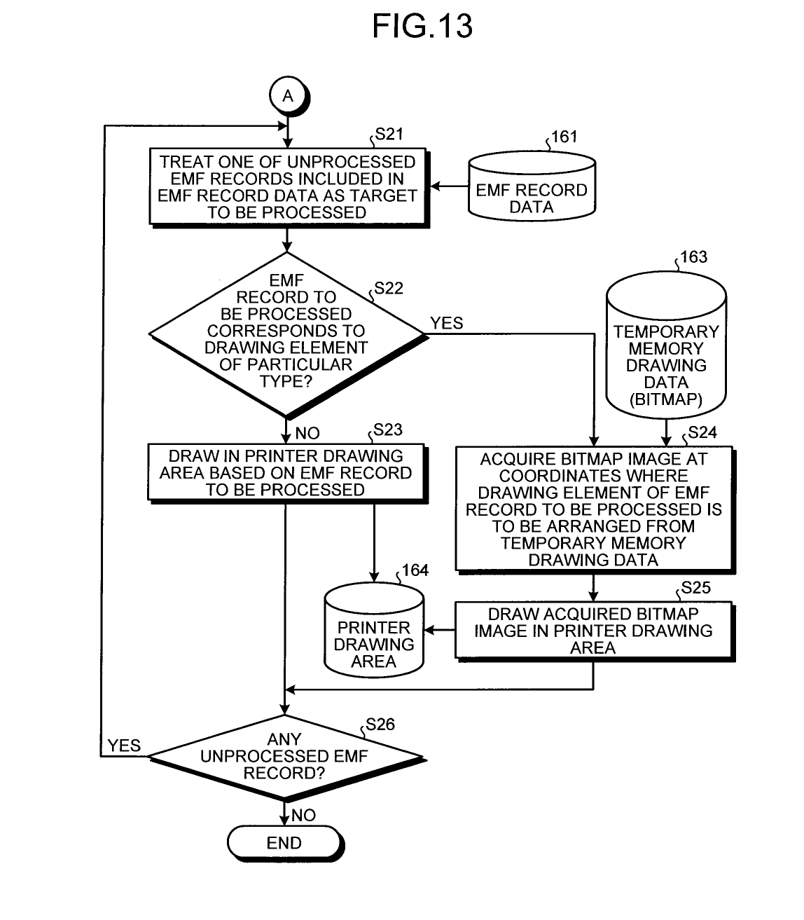

Next, a flow of a process when operations for generating print data are performed by the functions of respective units illustrated in FIG. 10 is described. FIG. 12 and FIG. 13 are flow charts illustrating the flow of that process. The process illustrated in these figures is performed by the CPU 11 of the PC 10 executing a required program.

When the CPU 11 detects that necessary processing excluding generation of print data has been completed on the EMF data 121 by the function of the output data generating unit 131, the CPU 11 starts the process in FIG. 12 with that processed EMF data being a target to be processed.

In this process, the CPU 11 first extracts an EMF record from the EMF data to be processed, and stores the extracted EMF record as EMF record data 161 (Step S11). This processing corresponds to the function of the EMF record extracting unit 151.

Next, the CPU 11 identifies an area in which data for a drawing element of a particular type that has been set beforehand are to be drawn, from the EMF record data 161, and stores coordinates of that area as the replacement rectangle data 162 (Step S12). This processing corresponds to the function of the EMF record extracting unit 151.

Next, the CPU 11 reserves a bitmap area on a memory (Step S13). Of the reserved bitmap area, an area required in drawing an area represented by the replacement rectangle data 162 is secured as a temporary memory drawing area 171, which is a temporary drawing area, and the rest of the area is released (Step S14). Thereafter, the CPU 11 draws a background in the secured temporary memory drawing area 171 (Step S15).

Further, the CPU 11 draws an image represented by the data for the drawing element of the particular type from among the EMF record data 161 in the temporary memory drawing area as a bitmap image to generate the temporary memory drawing data 163 (Step S16). Data of the temporary memory drawing area 171 after all of the drawing for the drawing element of the particular type has finished are the temporary memory drawing data 163. According to a specification of an API for drawing prepared by Windows (registered trademark), the EMF record data referred to in Step S16 are generated from the EMF data similarly to the case of Step S11, when the processing of Step S16 is performed. The processing of Steps S13 to S16 thus far is a first drawing process corresponding to the function of the temporary memory drawing unit 153.

The size of the area secured in Step S14 is a size required in drawing of each drawing element represented by the replacement rectangle data 162. This size is a total of sizes of areas corresponding to the respective drawing elements, and for each area for one drawing element, information indicating coordinates of that area is provided. At Step S16, an image represented by data for each drawing element is drawn in an area assigned with coordinates at which that drawing element is to be arranged.

After the above Step S16, the process advances to a part illustrated in FIG. 13. Processing in this part is a second drawing process corresponding to the function of the print data drawing unit 154.

The CPU 11 then treats one of unprocessed EMF records included in the EMF record data 161 as a target to be processed (Step S21). According to the specification of the API for drawing prepared by Windows (registered trademark), the EMF record data referred to in Step S21 are generated from the EMF data, similarly to the case of Step S11, when the processing of Step S21 is performed.

The CPU 11 then determines whether or not the EMF record to be processed corresponds a drawing element of the particular type (Step S22). If “No”, the CPU 11 performs drawing in the printer drawing area 164 based on the EMF record to be processed (Step S23). If “Yes” in Step S22, the CPU 11 acquires, from the temporary memory drawing data 163, a bitmap image at coordinates at which the drawing element of the EMF record to be processed is to be arranged (Step S24), and draws the acquired bitmap image in the printer drawing area 164 (Step S25).

In any case, if there is any unprocessed EMF record, the CPU 11 returns to Step S21 and repeats the processing with the next EMF record being a target to be treated (Step S26: Yes). When processing on all of the EMF records is completed (Step S26: No), the processing in FIG. 13 is ended.

By the above process, the CPU 11 is able to generate print data interpretable in PostScript.

### Comparative Example

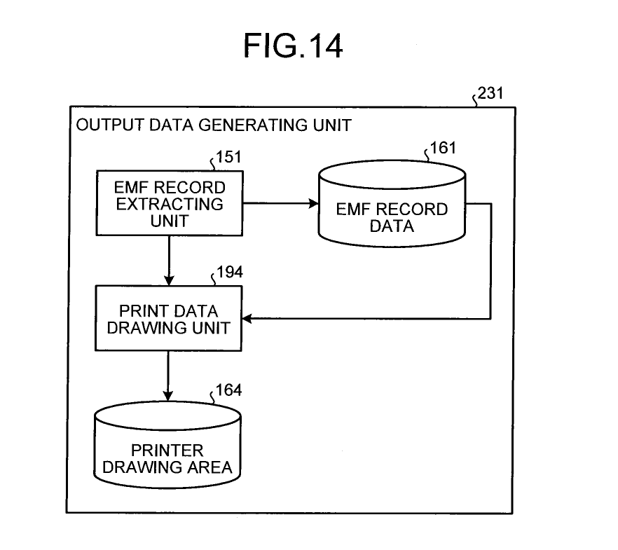

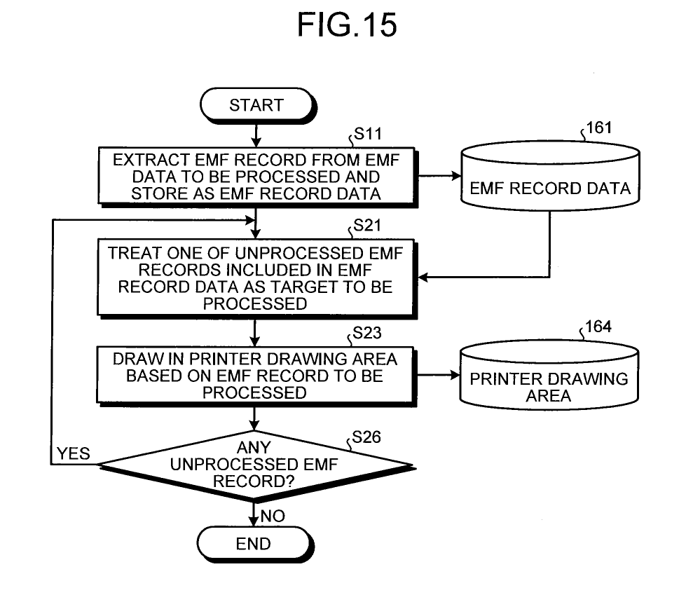

### FIG. 14 and FIG. 15

Next, by using a comparative example, effects of the above described embodiment will be described.

FIG. 14 illustrates a functional configuration of an output data generating unit in this comparative example.

This comparative example is the same as the above described embodiment, except that a configuration for processing EMF data by the output data generating unit is not the one illustrated in FIG. 10 but is the one illustrated in FIG. 14.

An output data generating unit 231 includes an EMF record extracting unit 151 and a print data drawing unit 194.

Of these, functions of the EMF record extracting unit 151 are the same as those illustrated in FIG. 10.

The print data drawing unit 194 has a function of a second drawing unit that performs, based on the EMF record data 161, drawing processing on the printer drawing area 164 to generate print data in the printer drawing area 164. Upon this drawing processing, all of drawing elements are written in the printer drawing area 164 as they are.

Next, FIG. 15 illustrates a flow of a process when respective units illustrated in FIG. 14 perform operations for generating print data. FIG. 15 is a flow chart corresponding to FIG. 12 and FIG. 13.

In the process of FIG. 15, the processing of Step S11 of FIG. 12 and Steps S21, S23, and S26 of FIG. 13 are sequentially performed.

Print data that are able to be processed by the printer driver 220 are able to be generated by the above process, though not satisfactorily. However, the print data generated by the process of FIG. 15 may include a drawing element not interpretable in PostScript and if these print data are used, a defect as illustrated in FIG. 9 may occur in a print result.

In contrast, when print data are generated by the process illustrated in FIG. 12 and FIG. 13 according to the above described embodiment, such a problem does not occur.

### First Modified Example

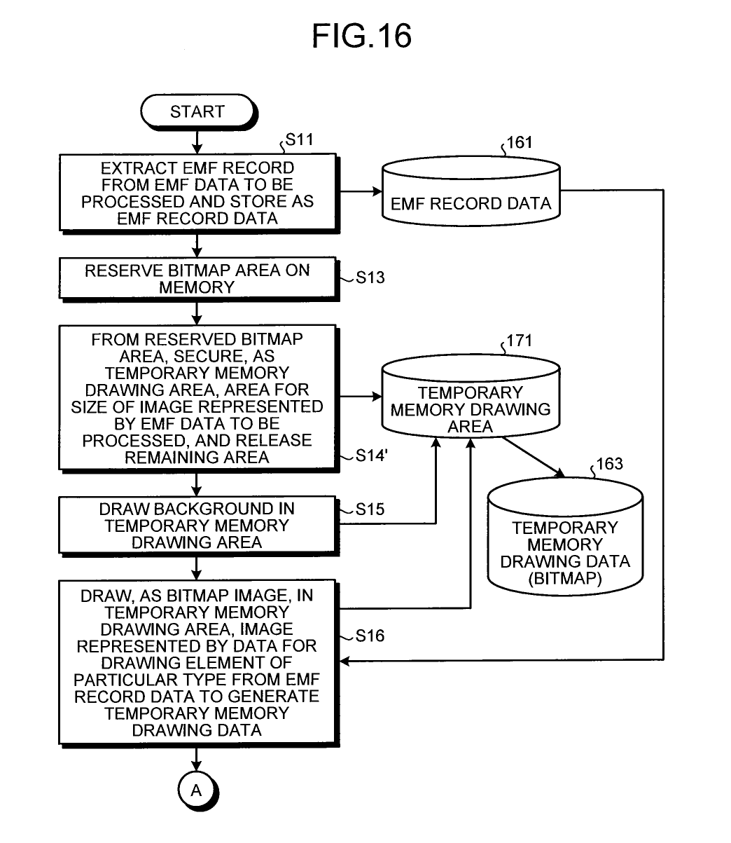

### FIG. 16

Next, a first modified example of the above described embodiment will be described.

This first modified example is different from the above described embodiment in the way in which the temporary memory drawing area 171 is secured, and accordingly, is different only in that instead of the processing of FIG. 12, a process of FIG. 16 is executed. Therefore, only this difference will be described.

The process of FIG. 16 is different from the process of FIG. 12 in that the process of FIG. 16 does not have Step S12 and that in the process of FIG. 16, instead of Step S14, processing of Step S14′ is performed. At Step S14′, the CPU 11 secures an area for a size of an image represented by the whole EMF data to be processed, from the bitmap area reserved in Step S13, as the temporary memory drawing area 171 and releases the rest of the area.

Accordingly, when drawing is performed in Step S16, an image represented by data for each drawing element is drawn at an address corresponding to coordinates at which that drawing element is to be arranged. At Step S24 of FIG. 13 also, a bitmap image may be obtained from an address corresponding to coordinates at which the relevant drawing element is to be arranged.

The rest of the process of FIG. 16 is in common with the processing of FIG. 12.

If this configuration is adopted, since the replacement rectangle data 162 are not used, the replacement rectangle extracting unit 152 is not necessary.

Even with such a configuration, print data are able to be generated similarly to the above described embodiment. However, in this modified example, a capacity of the memory used as the temporary memory drawing area 171 is larger than that of the above described embodiment. For A4-size, the capacity is about 120 megabytes. Therefore, for saving memory capacity, the process of the above described embodiment is preferable.

### Second Modified Example

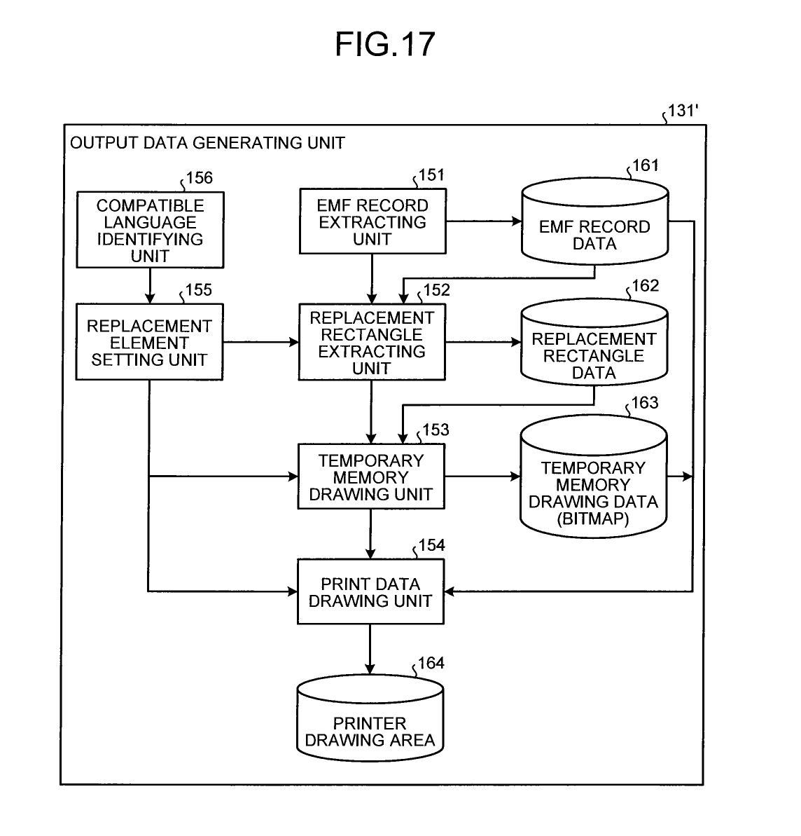

### FIG. 17

Next, a second modified example of the above described embodiment will be described.

This second modified example is different from the first embodiment only in that the type of drawing element to be the particular type is caused to be changeable. Therefore, only this difference will be described.

FIG. 17 illustrates a configuration of functions of an output data generating unit according to this second modified example.

An output data generating unit 131′ illustrated in FIG. 17 corresponds to the output data generating unit 131 illustrated in FIG. 10, that has been added with a replacement element setting unit 155 and a compatible language identifying unit 156.

The replacement element setting unit 155 has a function of a changing unit that changes criteria for determining a particular type of drawing element in the replacement rectangle extracting unit 152, temporary memory drawing unit 153, and print data drawing unit 154.

The compatible language identifying unit 156 has a function of an identifying unit that identifies a page description language format handled by the printer driver 220, which has become a transmission destination of print data.

If page description languages used by the printer drivers 220 are different, types of drawing element that are not interpretable are also different. Therefore, in association with a type of page description language, information on a type of drawing element not interpretable in that page description language is preferably prepared. According to a detection result by the compatible language identifying unit 156, the replacement element setting unit 155 changes a type of drawing element to be the particular type to a type corresponding to the page description language of that detection result.

As a result, even if the types of page description languages handled by the printer drivers 220a to 220c are different from one another, independently of a result of the selection of the output destination by the output destination selecting unit 132, print data interpretable by the printer driver 220 of the output destination are able to be generated. A page description language other than PostScript may be, for example, Printer Control Language (PCL) or PCL6.

The criteria for determining the particular type of drawing element set by the replacement element setting unit 155 may be caused to be manually editable by a user. If a drawing element to be the drawing element of the particular type is newly found during operation of the output data generating unit 131′, that drawing element may be added, for example. Further, a user may be caused to be able to manually change the determination criteria to be used correspondingly with any page description language. If the page description language to be used is determined, the processing is able to be made faster in this way.

The description of the embodiment will now be ended, but in this invention, the specific configuration of each unit, the number of devices, the processing sequences, the configuration and format of the treated data, and the like, are not limited to those described with reference to the embodiment.

Further, a switching unit, which enables or disables, automatically according to a user's operation or detection of any trigger event, the functions of drawing the bitmap image and replacing the drawing element of the particular type with the drawn bitmap image in the output data generating unit 131, may be provided. If the printer driver 220 to be used uses the same page description language as the virtual driver 110, there is considered to be no problem in the printing even if the above described replacement process is not performed. Therefore, if the function of the replacement is able to be disabled in such a case, the processing of the output data generating unit 131 is able to be speeded up and the memory usage is able to be reduced.

Further, the functions of the PC 10 in the above described embodiment may be provided by being arbitrarily distributed to a plurality of information processing apparatuses and these apparatuses may realize similar functions in corporation with one another. Particularly, the printer driver 220 may be provided in a print server prepared separately, without being provided in the printer driver 220. A system configured of the PC 10 itself or a plurality of such information processing apparatuses is an embodiment of an information processing system of this invention.

Further, the configurations of the above described embodiments and modified examples may of course be implemented by being arbitrarily combined with one another so long as no contradiction arises among them.

According to the above configuration, print data that are able to be properly processed by a printer driver are able to be generated.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus, comprising:
a first drawing unit that draws graphic data of a predetermined format as a bitmap image in a temporary drawing area; and
a second drawing unit that performs drawing processing based on the graphic data of the predetermined format to generate print data, and uses, as a drawing result with respect to a drawing element of a particular type that has been predetermined, the particular type being of types of drawing elements defined in the predetermined format, an image at coordinates where the drawing element is to be arranged, the image being of the bitmap image drawn in the temporary drawing area by the first drawing unit.

2. The information processing apparatus according to claim 1, wherein the first drawing unit selects the drawing element of the particular type from the graphic data to draw, as the bitmap image, the selected drawing element in the temporary drawing area, and secures an area of a size required in drawing of the drawing element of the particular type as the temporary drawing area.

3. The information processing apparatus according to claim 1, further comprising a changing unit that changes a type of drawing element to be the particular type.

4. The information processing apparatus according to claim 1, further comprising a switching unit that enables or disables: a function of the first drawing unit; and a function of the second drawing unit using the bitmap image of the temporary drawing area in the drawing of the drawing element of the particular type.

5. The information processing apparatus according to claim 1, further comprising:
a selecting unit that selects a page description language to which the print data the second drawing unit is caused to generate correspond; and
a setting unit that sets, according to the page description language selected by the selecting unit, a type of drawing element to be the particular type.

6. The information processing apparatus according to claim 1, further comprising:
an identifying unit that identifies a format of a page description language handled by a printer driver that controls printing based on the print data generated by the second drawing unit; and
a setting unit that sets, according to the page description language identified by the identifying unit, a type of drawing element to be the particular type.

7. The information processing apparatus according to claim 1, further comprising:
a selecting unit that selects, according to a predetermined rule, a printer driver caused to control printing based on the print data generated by the second drawing unit;
an identifying unit that identifies a format of a page description language handled by the printer driver selected by the selecting unit; and
a setting unit that sets, according to the page description language identified by the identifying unit, a type of drawing element to be the particular type.

8. An information processing method, comprising:
first drawing including drawing graphic data of a predetermined format as a bitmap image in a temporary drawing area; and
second drawing including performing drawing processing based on the graphic data of the predetermined format to generate print data, and using, as a drawing result with respect to a drawing element of a particular type that has been predetermined, the particular type being of types of drawing elements defined in the predetermined format, an image at coordinates where the drawing element is to be arranged, the image being of the bitmap image drawn in the temporary drawing area at the first drawing.

9. An information processing system, comprising:
a first drawing unit that draws graphic data of a predetermined format as a bitmap image in a temporary drawing area; and
a second drawing unit that performs drawing processing based on the graphic data of the predetermined format to generate print data, and uses, as a drawing result with respect to a drawing element of a particular type that has been predetermined, the particular type being of types of drawing elements defined in the predetermined format, an image at coordinates where the drawing element is to be arranged, the image being of the bitmap image drawn in the temporary drawing area by the first drawing unit.
